(19) United States
(12) Patent Application Publication
(10) Pub. No.: US 2025/0164089 A1
(43) Pub. Date: May 22, 2025

(54) LED LIGHT EMITTING STRUCTURE AND HEADLAMP THEREOF

(71) Applicant: Wenjie LI, Guangzhou (CN)

(72) Inventor: Wenjie LI, Guangzhou (CN)

(21) Appl. No.: 18/605,158

(22) Filed: Mar. 14, 2024

(30) Foreign Application Priority Data
Nov. 16, 2023 (CN) 202323108231.8

(51) Int. Cl. F21S 41/153; F21S 41/125; F21Y 113/13; F21Y 115/10

(52) U.S. Cl. CPC F21S 41/153; F21S 41/125; F21Y 2113/13; F21Y 2115/10

(57) ABSTRACT

The present invention relates to the technical field of LED lamp beads of headlamps, in particular to an LED light emitting structure and a headlamp thereof, wherein the LED light emitting structure includes an LED lamp bead set, the LED lamp bead set includes at least two LED lamp beads, each of the LED lamp beads includes a lens and an LED chip set, the lens is disposed above the LED chip set, the LED chip set includes at least two LED chips with at least one being a first LED chip and at least one being a second LED chip, and the first LED chip and the second LED chip are different in color temperature or color. When the LED chip with a certain color temperature or color is controlled by the present invention, the LED chips with corresponding color temperatures or colors in all the LED lamp beads will emit light, at the moment, the lens located above the LED chip with the color temperature or color and a reflective surface in the lens can be both used, which increases the utilization ratio of the lens, and then improves a lighting effect.

### CROSS-REFERENCE TO RELATED APPLICATION

This application claims the priority benefit of China application serial no. 202323108231.8, filed on 16 Nov. 2023. The entirety of the above-mentioned patent application is hereby incorporated by reference herein and made a part of this specification.

### TECHNICAL FIELD

The present invention relates to the technical field of LED lamp beads of headlamps, and in particular relates to an LED light emitting structure and a headlamp thereof.

### BACKGROUND

LED, namely light emitting diode, is a semiconductor solid light emitting device. It takes a solid semiconductor chip as a light emitting material, and emits excess energy through carrier recombination in semiconductors to cause photon emission, thereby directly emitting red, yellow, blue, and green light. On this basis, light with any color can be emitted by adding phosphors based on the three primary color principle.

In recent years, LEDs have been widely used in lighting devices, especially in the field of headlamp applications. In a conventional LED headlamp with double light sources, LED chips with different color temperatures and colors are separately packaged in different lamp beads, and are in one-to-one correspondence with lenses. If the LED lamp bead with one of the color temperatures or colors is separately controlled to emit light, the lens corresponding to the LED lamp bead with the other color temperature or color and a reflective surface in the lens cannot be used, so that the utilization ratio of the reflection area is insufficient, and the utilization ratio of the lens is low, which causes a poorer lighting effect.

According to the total reflection principle of light, the greater the reflection area is, the better the long-distance emission effect is. Therefore, in order to improve the long-distance emission effect, in addition to controlling the light efficiency by using a total reflection lens, improving the utilization ratio of the lens has become the key to further optimize the lighting effect.

### SUMMARY OF THE INVENTION

In order to overcome technical problems of low utilization ratio of a lens and poor lighting effect caused by one-to-one correspondence between the lens and a single-chip lamp bead in the above-mentioned prior art, the present invention provides an LED light emitting structure which is high in utilization ratio of a lens and good in lighting effect, and a headlamp thereof.

In order to solve the above-mentioned technical problems, the present invention adopts a technical solution that an LED light emitting structure includes an LED lamp bead set, wherein the LED lamp bead set includes at least two LED lamp beads, each of the LED lamp beads includes a lens and an LED chip set, the lens is disposed above the LED chip set, the LED chip set includes at least two LED chips with at least one being a first LED chip and at least one being a second LED chip, and the first LED chip and the second LED chip are different in color temperature or color.

In the present invention, one lens at least corresponds to two LED chips, and the LED chip set at least includes two LED chips with different color temperatures or colors. During use, all the LED chips with the same color temperature or color in the same LED lamp bead or different LED lamp beads in the LED lamp bead set can be controlled to emit light at the same time. When the LED chip with a certain color temperature or color is controlled, the LED chips with corresponding color temperatures or colors in all the LED lamp beads will emit light, at the moment, the lens located above the LED chip with the color temperature or color and a reflective surface in the lens can be both used, which increases the utilization ratio of reflection areas of the lenses, and then improves a lighting effect.

Preferably, all the LED chips in the LED chip set are arranged in a matrix.

Preferably, the LED chip set includes two LED chips which are a first LED chip and a second LED chip, respectively.

Preferably, the LED chip set includes four LED chips with two being first LED chips and the other two being second LED chips.

Preferably, the four LED chips are arranged in a 2×2 matrix, and the two first LED chips or the two second LED chips are located on the same row or the same column or on a diagonal line.

Preferably, all the LED lamp beads in the LED lamp bead set are arranged in a matrix.

Preferably, all the LED chips in the LED lamp bead set disposed in an even number of columns are disposed in vertical symmetry, or/and all the LED chips in the LED lamp bead set disposed in an even number of rows are disposed in horizontal symmetry.

Preferably, the LED lamp bead set is at least disposed in two columns and is at least disposed in two rows, adjacent four LED lamp beads form a local LED lamp bead set, and the local LED lamp bead set is arranged in a 2×2 matrix.

Preferably, all the LED chips in the local LED lamp bead set are disposed in horizontal symmetry or/and vertical symmetry or/and central symmetry.

A headlamp includes the above-mentioned LED light emitting structure.

Compared with the prior art, the present invention has the beneficial effects:

1) in the present invention, at least two LED chips are disposed in the LED lamp beads, the at least two LED chips include at least two LED chips with different color temperatures or colors, when the LED chip with one of the color temperatures or the colors is used, the LED chips with corresponding color temperatures or colors in all the LED lamp beads will emit light, at the moment, the lens located above the LED chip with the color temperature or color and a reflective surface in the lens can be both used, which can increase the reflection area of the lens and increase the utilization ratio of the lens, thereby being beneficial to the achievement of a better long-distance emission effect; and

2) in the present invention, by adjusting collocation positions of the LED lamp beads, and combining and arranging the LED lamp beads in the matrix in ways such as axial symmetry and central symmetry of the LED chips, when only parts of chips are lit, a symmetry compensation effect for light emission is achieved by combination and collocation, so that a light shape is balanced, and a spot effect of smooth transition from the center to edges can be formed, and finally, the use experience of the headlamp is improved.

### BRIEF DESCRIPTION OF THE DRAWINGS

FIG. 1 is a schematic structural diagram of an LED lamp bead of an existing LED headlamp with double light sources;

FIG. 2 is a schematic structural diagram of embodiment 1 of an LED light emitting structure in the present invention;

FIG. 3 is a schematic structural diagram of embodiment 2 of an LED light emitting structure in the present invention;

FIG. 4 is a schematic structural diagram of embodiment 3 of an LED light emitting structure in the present invention;

FIG. 5 is a schematic structural diagram of embodiment 4 of an LED light emitting structure in the present invention;

FIG. 6 is a schematic structural diagram of embodiment 5 of an LED light emitting structure in the present invention;

FIG. 7 is a schematic structural diagram of embodiment 6 of an LED light emitting structure in the present invention;

FIG. 8 is a schematic structural diagram of embodiment 7 of an LED light emitting structure in the present invention;

FIG. 9 is a schematic structural diagram of embodiment 8 of an LED light emitting structure in the present invention;

FIG. 10 is a schematic structural diagram of embodiment 9 of an LED light emitting structure in the present invention;

FIG. 11 is a schematic structural diagram of embodiment 10 of an LED light emitting structure in the present invention; and

FIG. 12 is a schematic structural diagram of embodiment 11 of an LED light emitting structure in the present invention.

In the accompanying drawings: 1—LED lamp bead set; 11—LED lamp bead; 12—local LED lamp bead set; 121—first local LED lamp bead set; 122—second local LED lamp bead set; 123—third local LED lamp bead set; 124—fourth local LED lamp bead set; 2—lens; 3—LED chip set; 4—LED chip; 41—first LED chip; 42—second LED chip; and 101—lamp cap.

### DETAILED DESCRIPTION OF THE INVENTION

The accompanying drawings are only for the purpose of exemplary description, but cannot be understood as limitations on the present patent. In order to better describe the present embodiments, some components in the accompanying drawings will be omitted, enlarged or reduced, which does not represent the size of an actual product. For the skilled in the art, it can be understood that some known structures or descriptions in the accompanying drawings may be omitted. Positional relationships described in the accompanying drawings are only for the purpose of exemplary description, but cannot be understood as limitations on the present patent.

The same or similar reference numerals in the accompanying drawings of the embodiments of the present invention correspond to the same or similar components. In the description of the present invention, it should be understood that directional or positional relationships indicated by terms such as “upper”, “lower”, “left”, “right”, “long” and “short” are based on directional or positional relationships as shown in the accompanying drawings, and are only for the purposes of facilitating describing the present invention and simplifying the description, rather than indicating or implying that the referred device or element has to have a specific direction or be constructed and operated in the specific direction, and therefore, the terms for describing the positional relationships in the accompanying drawings are only for the purpose of exemplary description, but cannot be understood as limitations on the present patent. Those of ordinary skill in the art may understand the specific meanings of the above-mentioned terms according to specific situations.

As shown in FIG. 1, for a conventional LED headlamp with double light sources, two LED lamp beads 11 are usually disposed in a lamp cap 101. The LED lamp beads 11 include lenses 2 and LED chips 4. One of the LED chips 4 is packaged in each of the LED lamp beads 11, and the LED chips 4 in the two LED lamp beads 11 are different in color temperature or color, being a first LED chip 41 and a second LED chip 42, respectively. If the LED lamp bead 11 with one of the color temperatures or colors is separately controlled to emit light, the lens 2 corresponding to the LED lamp bead 11 with the other color temperature or color and a reflective surface in the lens 2 cannot be used, so that the utilization ratio of the reflection area of the lens 2 is insufficient, and then, the utilization ratio of the lens 2 is low, which causes a poorer lighting effect of the headlamp.

In order to solve the problems, the present invention provides an LED light emitting structure high in utilization ratio of a lens and good in lighting effect. The technical solution of the present invention will be further specifically described below with specific embodiments in conjunction with the accompanying drawings:

### Embodiment 1

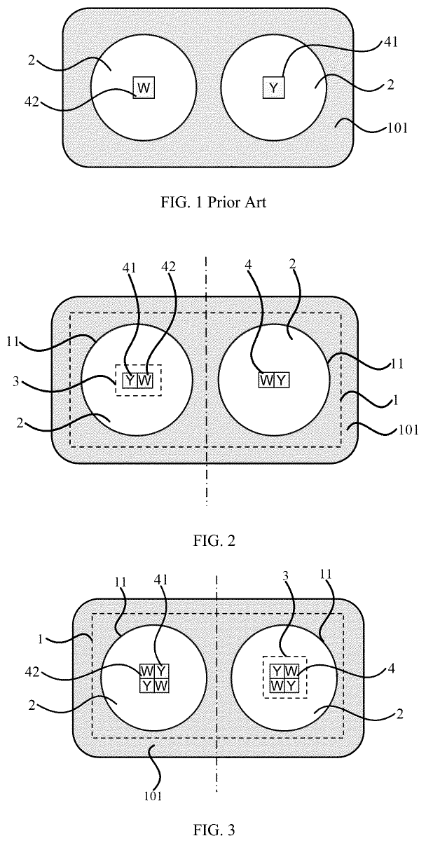

As shown in FIG. 2, embodiment 1 of an LED light emitting structure includes an LED lamp bead set 1, wherein the LED lamp bead set 1 includes at least two LED lamp beads 11, each of the LED lamp beads 11 includes a support, a lens 2, an LED chip set 3, and a conducting element. The LED chip set 3 is disposed on the upper end of the support and is packaged in the lens 2, that is, the lens 2 is disposed above the LED chip set 3, the conducting element is disposed on the lower end of the support and is electrically connected to the LED chip set 3 so as to be capable of supplying power for the LED chip set 3.

The LED chip set 3 includes at least two LED chips 4, all the LED chips 4 in the LED chip set 3 may be different in color temperature or color, and the LED chips 4 with different color temperatures or colors in the LED chip set 3 can be separately controlled to emit light. In the present embodiment, the LED chip set 3 at least includes two LED chips 4 with different color temperatures or colors. Specifically, in the present embodiment, the LED chip set 3 includes the LED chips 4 with at least one being a first LED chip 41 and at least one being a second LED chip 42, and the first LED chip 41 and the second LED chip 42 are different in color temperature or color.

All the LED chips 4 with the same color temperature or color in the same LED lamp bead 11 or different LED lamp beads 11 in the LED lamp bead set 1 can be controlled to emit light at the same time. When the LED chip 4 with a certain color temperature or color is controlled, the LED chips 4 with corresponding color temperatures or colors in all the LED lamp beads 11 will emit light, at the moment, reflective surfaces of all the lenses 2 can be utilized, which greatly increases the utilization ratio of the lenses 2, and is then beneficial to the improvement of a lighting effect.

In the present embodiment, all the LED chips 4 in the LED chip set 3 are arranged in a matrix. Specifically, as shown in FIG. 2, in the present embodiment, the LED lamp bead set 1 includes two LED lamp beads 11 which are located in the same row, each of the LED lamp beads 11 is internally provided with the two LED chips 4 which are the first LED chip 41 and the second LED chip 42, respectively, and the first LED chip 41 and the second LED chip 42 are located in the same row and are different in color temperature or color. In order to achieve a more intuitive show, in the accompanying drawing of the present embodiment, the first LED chip 41 is marked as “Y”, and the second LED chip 42 is marked as “W”.

When the first LED chip 41 (Y) or the second LED chip 42 (W) is controlled to emit light, the first LED chip 41 (Y) and the second LED chip 42 (W) of the two LED lamp beads 2 can both emit light. Compared with traditional LED lamp beads which are only provided with one LED chip, each of the two LED lamp beads is internally provided with the two LED chips with different color temperatures or colors, when the LED chip with one of the color temperatures is separately controlled to emit light, the lens corresponding to the LED chip with the other color temperature and a reflective surface in the lens cannot be used. In the present embodiment, reflective surfaces of the lenses 2 of the two LED lamp beads 11 can be both used, which increases the utilization ratio of the reflection areas of the lenses, and then, improves the lighting effect.

In order to further improve the lighting effect to form a stable rectangular spot, the allocation positions of the LED chips 4 in the LED lamp beads 11 can be adjusted to achieve a symmetry compensation effect for light emission. Specifically, all the LED lamp beads 11 in the LED lamp bead set 1 are arranged in a matrix, the number and types of the LED chips 4 disposed in all the LED lamp beads 11 are both the same, but the arrangement positions of the LED chips 4 are adjusted according to symmetry compensation.

The number of columns of the LED lamp bead set 1 is set to be an even number, and all the LED chips 4 in the LED lamp bead set 1 are disposed in vertical symmetry; and the number of rows of the LED lamp bead set 1 is set to be an even number, and all the LED chips 4 in the LED lamp bead set 1 are disposed in horizontal symmetry.

In the present embodiment, the LED lamp bead set 1 includes two LED lamp beads 11 which are located in the same row, that is, the number of the columns of the LED lamp bead set 1 is set to be the even number, each of the LED lamp beads 11 is internally provided with two LED chips 4 which are located in the same row, and the LED chips 4 in the two LED lamp beads 11 are disposed in vertical symmetry. Specifically, the LED chips 4 in one of the LED lamp beads 11 are arranged as “YW” in sequence from left to right, and the LED chips 4 in the other LED lamp bead 11 are arranged as “WY” in sequence from left to right. By such an arrangement, bilateral symmetry complementation can be formed, it is convenient to form the stable rectangular spot on the basis of increasing the use efficiency of the lens 2, and the lighting effect is further improved.

The present embodiment further provides a headlamp, and a lamp cap 101 of the headlamp is decorated with the LED light emitting structure in the present embodiment. The utilization ratio of the reflection areas of the lenses of the LED light emitting structure in the present embodiment is high, and thus, the lighting effect of the whole headlamp can be improved.

### Embodiment 2

The present embodiment is embodiment 2 of an LED light emitting structure. The present embodiment differs from embodiment 1 in that: as shown in FIG. 3, in the present embodiment, an LED lamp bead set 1 includes two LED lamp beads 11 which are located in the same row, that is, the two LED lamp beads are arranged in a 1×2 matrix. Each of the LED lamp beads 11 is internally provided with four LED chips 4 which are two first LED chips 41 and two second LED chips 42, respectively. The four LED chips 4 are arranged in a 2×2 matrix, and the two first LED chips 41 or the two second LED chips 42 are located in the same row or the same column or on a diagonal line.

In the present embodiment, the two first LED chips 41 or the two second LED chips 42 are located on the diagonal line, and the LED chips 4 in the two LED lamp beads 11 are disposed in vertical symmetry so as to have a bilateral symmetry complementation effect.

### Embodiment 3

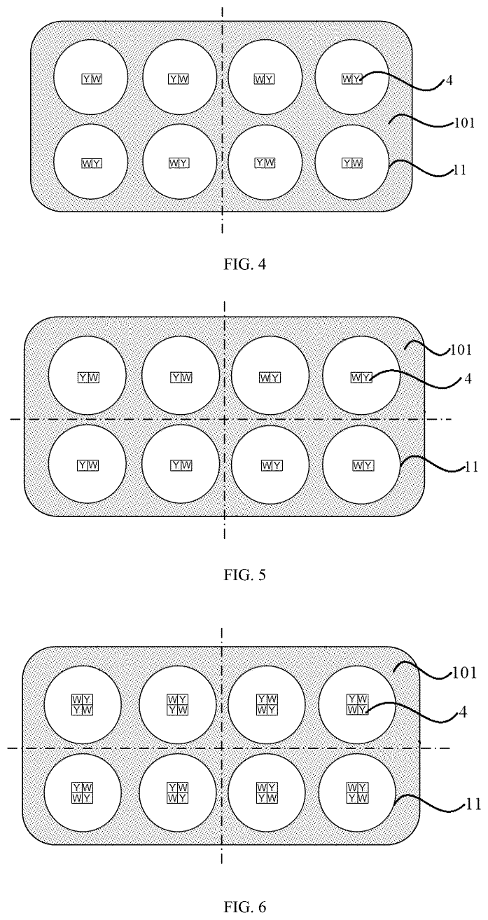

The present embodiment is embodiment 3 of an LED light emitting structure. The present embodiment differs from embodiment 1 in that: as shown in FIG. 4, in the present embodiment, an LED lamp bead set 1 includes eight LED lamp beads 11 which are arranged in a 2×4 matrix, and each of the LED lamp beads 11 is internally provided with two LED chips 4 which are a first LED chip 41 and a second LED chip 42, respectively.

In the present embodiment, all the LED chips 4 of the eight LED lamp beads 11 are disposed in vertical symmetry so as to have a bilateral symmetry complementation effect.

### Embodiment 4

The present embodiment is embodiment 4 of an LED light emitting structure. The present embodiment differs from embodiment 1 in that: as shown in FIG. 5, in the present embodiment, an LED lamp bead set 1 includes eight LED lamp beads 11 which are arranged in a 2×4 matrix, and each of the LED lamp beads 11 is internally provided with two LED chips 4 which are a first LED chip 41 and a second LED chip 42, respectively.

In the present embodiment, all the LED chips 4 of the eight LED lamp beads 11 are disposed in vertical symmetry and horizontal symmetry so as to have bilateral symmetry complementation and longitudinal symmetry complementation effects.

### Embodiment 5

The present embodiment is embodiment 5 of an LED light emitting structure. The present embodiment differs from embodiment 1 in that: as shown in FIG. 6, in the present embodiment, an LED lamp bead set 1 includes eight LED lamp beads 11 which are arranged in a 2×4 matrix. Each of the LED lamp beads 11 is internally provided with four LED chips 4 which are two first LED chips 41 and two second LED chips 42, respectively, the four LED chips 4 are arranged in a 2×2 matrix, and the two first LED chips 41 or the two second LED chips 42 are located on a diagonal line.

In the present embodiment, all the LED chips 4 of the eight LED lamp beads 11 are disposed in vertical symmetry and horizontal symmetry so as to have bilateral symmetry complementation and longitudinal symmetry complementation effects.

### Embodiment 6

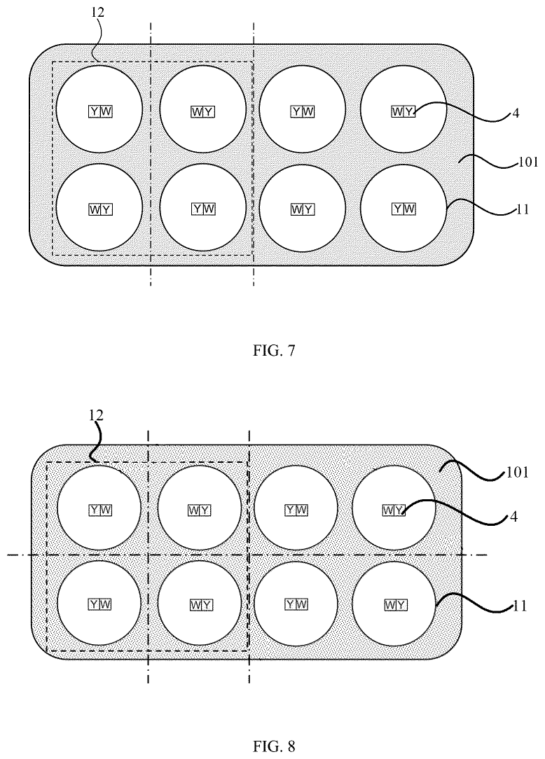

The present embodiment is embodiment 6 of an LED light emitting structure. The present embodiment differs from embodiment 1 in that: as shown in FIG. 7, in the present embodiment, an LED lamp bead set 1 is at least disposed in two columns and is at least disposed in two rows, adjacent four LED lamp beads 11 form a local LED lamp bead set 12, the LED lamp beads 11 in the local LED lamp bead set 12 are arranged in a 2×2 matrix, and all the LED chips 4 in the local LED lamp bead set 12 are disposed in horizontal symmetry or/and vertical symmetry or/and central symmetry.

In the present embodiment, the LED lamp bead set 1 includes eight LED lamp beads 11 which are arranged in a 2×4 matrix, and each of the LED lamp beads 11 is internally provided with two LED chips 4 which are a first LED chip 41 and a second LED chip 42, respectively.

In the present embodiment, all the LED chips 4 of the eight LED lamp beads 11 are disposed in vertical symmetry as a whole so as to have a global bilateral symmetry complementation effect. At the same time, the four LED lamp beads 11 on the left and the four LED lamp beads 11 on the right form two local LED lamp bead sets 12, respectively, and all the LED chips 4 in the two local LED lamp bead sets 12 are disposed in vertical symmetry so as to have a local bilateral symmetry complementation effect.

### Embodiment 7

The present embodiment is embodiment 7 of an LED light emitting structure. The present embodiment differs from embodiment 6 in that: as shown in FIG. 8, in the present embodiment, an LED lamp bead set 1 includes eight LED lamp beads 11 which are arranged in a 2×4 matrix, and each of the LED lamp beads 11 is internally provided with two LED chips 4 which are a first LED chip 41 and a second LED chip 42, respectively.

In the present embodiment, all the LED chips 4 of the eight LED lamp beads 11 are disposed in vertical symmetry and horizontal symmetry as a whole so as to have global bilateral symmetry complementation and global longitudinal symmetry complementation effects. At the same time, the four LED lamp beads 11 on the left and the four LED lamp beads 11 on the right form two local LED lamp bead sets 12, respectively, and all the LED chips 4 in the two local LED lamp bead sets 12 are disposed in vertical symmetry so as to have a local bilateral symmetry complementation effect.

### Embodiment 8

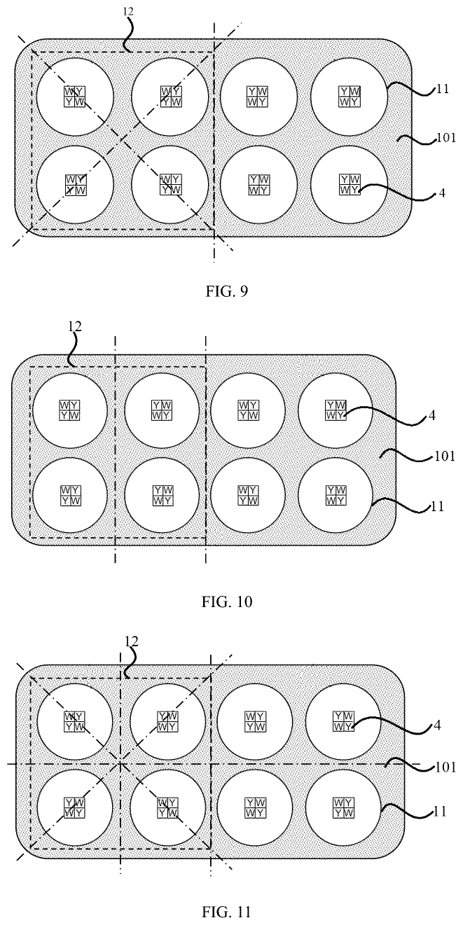

The present embodiment is embodiment 8 of an LED light emitting structure. The present embodiment differs from embodiment 6 in that: as shown in FIG. 9, in the present embodiment, an LED lamp bead set 1 includes eight LED lamp beads 11 which are arranged in a 2×4 matrix. Each of the LED lamp beads 11 is internally provided with four LED chips 4 which are two first LED chips 41 and two second LED chips 42, respectively, the four LED chips 4 are arranged in a 2×2 matrix, and the two first LED chips 41 or the two second LED chips 42 are located on a diagonal line.

In the present embodiment, all the LED chips 4 of the eight LED lamp beads 11 are disposed in vertical symmetry as a whole so as to have a global bilateral symmetry complementation effect. At the same time, the four LED lamp beads 11 on the left and the four LED lamp beads 11 on the right form two local LED lamp bead sets 12, respectively, and all the LED chips 4 in the two local LED lamp bead sets 12 are disposed in central symmetry so as to have a local central symmetry complementation effect.

### Embodiment 9

The present embodiment is embodiment 9 of an LED light emitting structure. The present embodiment differs from embodiment 6 in that: as shown in FIG. 10, in the present embodiment, an LED lamp bead set 1 includes eight LED lamp beads 11 which are arranged in a 2×4 matrix. Each of the LED lamp beads 11 is internally provided with four LED chips 4 which are two first LED chips 41 and two second LED chips 42, respectively, the four LED chips 4 are arranged in a 2×2 matrix, and the two first LED chips 41 or the two second LED chips 42 are located on a diagonal line.

In the present embodiment, all the LED chips 4 of the eight LED lamp beads 11 are disposed in vertical symmetry as a whole so as to have a global bilateral symmetry complementation effect. At the same time, the four LED lamp beads 11 on the left and the four LED lamp beads 11 on the right form two local LED lamp bead sets 12, respectively, and all the LED chips 4 in the two local LED lamp bead sets 12 are disposed in vertical symmetry so as to have a local bilateral symmetry complementation effect.

### Embodiment 10

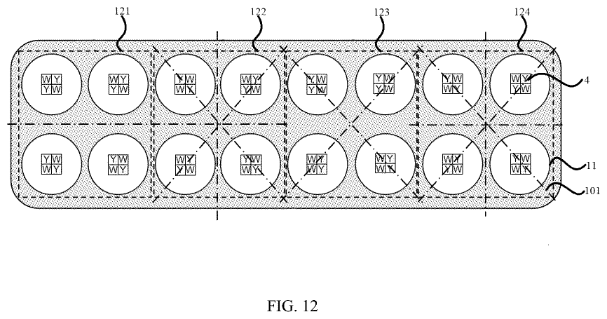

The present embodiment is embodiment 10 of an LED light emitting structure. The present embodiment differs from embodiment 6 in that: as shown in FIG. 11, in the present embodiment, an LED lamp bead set 1 includes eight LED lamp beads 11 which are arranged in a 2×4 matrix. Each of the LED lamp beads 11 is internally provided with four LED chips 4 which are two first LED chips 41 and two second LED chips 42, respectively, the four LED chips 4 are arranged in a 2×2 matrix, and the two first LED chips 41 or the two second LED chips 42 are located on a diagonal line.

In the present embodiment, all the LED chips 4 of the eight LED lamp beads 11 are disposed in vertical symmetry and horizontal symmetry as a whole so as to have global bilateral symmetry complementation and longitudinal symmetry complementation effects. At the same time, the four LED lamp beads 11 on the left and the four LED lamp beads 11 on the right form two local LED lamp bead sets 12, respectively, and all the LED chips 4 in the two local LED lamp bead sets 12 are disposed in vertical symmetry and central symmetry so as to have local bilateral symmetry complementation and central symmetry complementation effects.

### Embodiment 11

The present embodiment is embodiment 11 of an LED light emitting structure. The present embodiment differs from embodiment 6 in that: as shown in FIG. 12, in the present embodiment, an LED lamp bead set 1 includes sixteen LED lamp beads 11 which are arranged in a 2×8 matrix. Each of the LED lamp beads 11 is internally provided with four LED chips 4 which are two first LED chips 41 and two second LED chips 42, respectively, and the four LED chips 4 are arranged in a 2×2 matrix.

The sixteen LED lamp beads 11 form four local LED lamp bead sets 12 in sequence from left to right, which are a first local LED lamp bead set 121, a second local LED lamp bead set 122, a third local LED lamp bead set 123, and a fourth local LED lamp bead set 124, respectively.

Wherein, in the present embodiment, the two first LED chips 41 or the two second LED chips 42 in each of the LED lamp beads 11 in the first local LED lamp bead set 121 are located on a diagonal line, and all the LED chips 4 in the first local LED lamp bead set 121 are disposed in horizontal symmetry so as to have a local longitudinal symmetry complementation effect.

In the present embodiment, the two first LED chips 41 or the two second LED chips 42 in each of the LED lamp beads 11 in the second local LED lamp bead set 122 are located on a diagonal line, and all the LED chips 4 in the second local LED lamp bead set 122 are disposed in horizontal symmetry, vertical symmetry and central symmetry so as to have local longitudinal symmetry complementation, local bilateral symmetry complementation and local central symmetry complementation effects.

In the present embodiment, the two first LED chips 41 or the two second LED chips 42 in each of the LED lamp beads 11 in the third local LED lamp bead set 123 are disposed in the same column, and all the LED chips 4 in the third local LED lamp bead set 123 are disposed in central symmetry so as to have a local central symmetry complementation effect.

In the present embodiment, the two first LED chips 41 or the two second LED chips 42 in each of the LED lamp beads 11 in the fourth local LED lamp bead set 124 are located on a diagonal line, and all the LED chips 4 in the fourth local LED lamp bead set 124 are disposed in horizontal symmetry, vertical symmetry and central symmetry so as to have local longitudinal symmetry complementation, local bilateral symmetry complementation and local central symmetry complementation effects.

Obviously, the above-mentioned embodiments of the present invention are only examples for clearly illustrating the present invention, but are not intended to limit implementations of the present invention. For those of ordinary skill in the art, various other changes and variations in different forms can be made on the basis of the above-mentioned description. All the implementations need not to be, and cannot be, exhaustive. Any modifications, equivalent substitutions, improvements, etc. made within the spirit and principle of the present invention should fall within the protection scope of the claims of the present invention.

1. An LED light emitting structure, comprising an LED lamp bead set, the LED lamp bead set comprising at least two LED lamp beads, wherein each of the LED lamp beads comprises a lens and an LED chip set, the lens is disposed above the LED chip set, the LED chip set comprises at least two LED chips with at least one being a first LED chip and at least one being a second LED chip, and the first LED chip and the second LED chip are different in color temperature or color,
wherein all the LED lamp beads in the LED lamp bead set are arranged in a matrix,
wherein the LED lamp bead set is at least disposed in two columns and is at least disposed in two rows, adjacent four LED lamp beads form a local LED lamp bead set, and the local LED lamp bead set is arranged in a 2×2 matrix.

2. The LED light emitting structure of claim 1, wherein all the LED chips in the LED chip set are arranged in a matrix.

3. The LED light emitting structure of claim 2, wherein the LED chip set comprises two LED chips which are the first LED chip and the second LED chip, respectively.

4. The LED light emitting structure of claim 2, wherein the LED chip set comprises four LED chips with two being the first LED chips and the other two being the second LED chips.

5. The LED light emitting structure of claim 4, wherein the four LED chips are arranged in a 2×2 matrix, and the two first LED chips or the two second LED chips are located on the same row or the same column or on a diagonal line.

6. (canceled)

7. The LED light emitting structure of claim 1, wherein all the LED chips in the LED lamp bead set disposed in an even number of columns are disposed in vertical symmetry, or/and all the LED chips in the LED lamp bead set disposed in an even number of rows are disposed in horizontal symmetry.

8. (canceled)

9. The LED light emitting structure of claim 1, wherein all the LED chips in the local LED lamp bead set are disposed in horizontal symmetry or/and vertical symmetry or/and central symmetry.

10. (canceled)

11. The LED light emitting structure of claim 2, wherein all the LED chips in the LED lamp bead set disposed in an even number of columns are disposed in vertical symmetry, or/and all the LED chips in the LED lamp bead set disposed in an even number of rows are disposed in horizontal symmetry.

12. (canceled)

13. The LED light emitting structure of claim 2, wherein all the LED chips in the local LED lamp bead set are disposed in horizontal symmetry or/and vertical symmetry or/and central symmetry.

14. (canceled)

15. The LED light emitting structure of claim 3, wherein all the LED chips in the LED lamp bead set disposed in an even number of columns are disposed in vertical symmetry, or/and all the LED chips in the LED lamp bead set disposed in an even number of rows are disposed in horizontal symmetry.

16. (canceled)

17. The LED light emitting structure of claim 3, wherein all the LED chips in the local LED lamp bead set are disposed in horizontal symmetry or/and vertical symmetry or/and central symmetry.

18. (canceled)

19. The LED light emitting structure of claim 4, wherein all the LED chips in the LED lamp bead set disposed in an even number of columns are disposed in vertical symmetry, or/and all the LED chips in the LED lamp bead set disposed in an even number of rows are disposed in horizontal symmetry.

20. (canceled)

21. The LED light emitting structure of claim 4, wherein all the LED chips in the local LED lamp bead set are disposed in horizontal symmetry or/and vertical symmetry or/and central symmetry.

22. (canceled)

23. The LED light emitting structure of claim 5, wherein all the LED chips in the LED lamp bead set disposed in an even number of columns are disposed in vertical symmetry, or/and all the LED chips in the LED lamp bead set disposed in an even number of rows are disposed in horizontal symmetry.

24. (canceled)

25. The LED light emitting structure of claim 5, wherein all the LED chips in the local LED lamp bead set are disposed in horizontal symmetry or/and vertical symmetry or/and central symmetry.

26. A headlamp, comprising the LED light emitting structure of claim 1.

27. A headlamp, comprising the LED light emitting structure of claim 2.

28. A headlamp, comprising the LED light emitting structure of claim 3.

29. A headlamp, comprising the LED light emitting structure of claim 4.

30. A headlamp, comprising the LED light emitting structure of claim 5.

31. (canceled)

32. A headlamp, comprising the LED light emitting structure of claim 7.

33. (canceled)

34. A headlamp, comprising the LED light emitting structure of claim 9.

35. (canceled)

36. A headlamp, comprising the LED light emitting structure of claim 11.

37. (canceled)

38. A headlamp, comprising the LED light emitting structure of claim 13.

39. (canceled)

40. A headlamp, comprising the LED light emitting structure of claim 15.

41. (canceled)

42. A headlamp, comprising the LED light emitting structure of claim 17.

43. (canceled)

44. A headlamp, comprising the LED light emitting structure of claim 19.

45. (canceled)

46. A headlamp, comprising the LED light emitting structure of claim 21.

47. (canceled)

48. A headlamp, comprising the LED light emitting structure of claim 23.

49. (canceled)

50. A headlamp, comprising the LED light emitting structure of claim 25.
